(19) United States
(12) Patent Application Publication
(10) Pub. No.: US 2011/0290733 A1
(43) Pub. Date: Dec. 1, 2011

(54) METHOD AND APPARATUS FOR REMOVING SELENIUM FROM WATER

(76) Inventors: Eric Vogler, Albuquerque, NM (US); Frank Huang, Socorro, NM (US)

(21) Appl. No.: 13/015,552

(22) Filed: Jan. 27, 2011

Related U.S. Application Data
(63) Continuation-in-part of application No. 12/787,035, filed on May 25, 2010.

(51) Int. Cl. C02F 1/58; C02F 1/463; C02F 1/66; C02F 1/42

(52) U.S. Cl. 210/668; 210/663; 210/202; 210/702; 205/742

(57) ABSTRACT

Methods of and apparatuses for removing selenium from water. Sulfate and organics are first removed to discourage such materials from overwhelming subsequent processing of water to remove selenium.

### CROSS REFERENCE TO RELATED APPLICATIONS

This application claims priority as a continuation in part of U.S. utility application Ser. No. 12/787,035, filed May 25, 2010, which is incorporated herein by reference.

### BACKGROUND

The present invention relates to methods and apparatuses for removing selenium from water.

Selenium is a chemical element with the atomic number 34, represented by the chemical symbol Se, with an atomic mass of 78.96. It is a nonmetal, chemically related to sulfur and tellurium, and rarely occurs in its elemental state in nature. Isolated selenium occurs in several different forms, the most stable of which is a dense purplish-gray semi-metal (semiconductor) form that is structurally a trigonal polymer chain. It conducts electricity better in the light than in the dark, and is used in photocells. Selenium also exists in many non-conductive forms: a black glass-like allotrope, as well as several red crystalline forms built of eight-membered ring molecules, similar to sulfur. Selenium is found in economic quantities in sulfide ores such as pyrite, partially replacing the sulfur in the ore matrix. Minerals that are selenide or selenate compounds are also known, but are rare. The chief commercial uses for selenium today are in glassmaking and in chemicals and pigments. Uses in electronics, once important, have been supplanted by silicon semiconductor devices. Selenium salts are toxic in large amounts, but trace amounts of the element are necessary for cellular function in most, if not all, animals, forming the active center of the enzymes glutathione peroxidase and thioredoxin reductase (which indirectly reduce certain oxidized molecules in animals and some plants) and three known deiodinase enzymes (which convert one thyroid hormone to another). Selenium requirements in plants differ by species, with some plants apparently requiring none.

Although selenium is an essential trace element, it is toxic if taken in excess. Exceeding the Tolerable Upper Intake Level of 400 micrograms per day can lead to selenosis. This 400 microgram Tolerable Upper Intake Level is primarily based on a 1986 study of five Chinese patients who exhibited overt signs of selenosis and a follow up study on the same five people in 1992. The 1992 study actually found the maximum safe dietary Se intake to be approximately 800 micrograms per day (15 micrograms per kilogram body weight), but suggested 400 micrograms per day to not only avoid toxicity, but also to avoid creating an imbalance of nutrients in the diet and to account for data from other countries. The Chinese people that suffered from selenium toxicity ingested selenium by eating corn grown in extremely selenium-rich stony coal (carbonaceous shale). This coal was shown to have selenium content as high as 9.1%, the highest concentration in coal ever recorded in literature. A dose of selenium as small as 5 mg per day can be lethal for many humans.

Selenium (Se) co-exists with sulfur in crude oil and coal. During the oil refining process, selenium is released into wastewater. Typically, oily wastewater streams are first treated using corrugated plate interceptor (similar to lamella clarifier) and induced static flotation (similar to dissolved gas flotation) to remove solids and oil. The treated wastewater is then discharged into activated sludge process or aerated lagoon for BOD removal. The selenium concentration in the oil refinery secondary effluent can be as high as several hundred parts per billion (ppb). For coal-fired power plants, elevated selenium concentrations are also present in wastewater contained in ash ponds and generated from scrubbers. Selenium exists as selenite, Se (IV) and selenate, Se (VI). Because of the chemical similarity of sulfur to selenium and the relative abundance of sulfate to selenium species in wastewater, sulfate competes strongly with selenium species for binding sites during treatment leading to a significant reduction in selenium removal.

There is a need for methods and apparatuses that can remove selenium from water, such as wastewater from oil refinery and coal-fired power plants, in cost-effective and efficient manners.

### SUMMARY OF THE INVENTION

Embodiments of the present invention provide methods and apparatuses for removing selenium from water.

The advantages and features of novelty that characterize the present invention are pointed out with particularity in the claims annexed hereto and forming a part hereof. However, for a thorough understanding of the invention and the methods of its making and using, reference should be made to the drawings which form a further part hereof, and to the accompanying descriptive matter in which there are illustrated and described example embodiments of the present invention. The description below involves specific examples; those skilled in the art will appreciate other examples from the teachings herein, and combinations of the teachings of the examples.

### BRIEF DESCRIPTION OF THE DRAWINGS

The accompanying drawings, which are incorporated in and form part of the specification, illustrate the present invention and, together with the description, describe the invention by way of various example embodiments.

FIG. 1 is a schematic illustration of an example method according to the present invention.

FIG. 2 is a schematic illustration of an example method according to the present invention.

FIG. 3 is a schematic illustration of an example method according to the present invention.

FIG. 4 is a schematic illustration of an example method according to the present invention.

FIG. 5 is a schematic illustration of an example method according to the present invention.

FIG. 6 is a schematic illustration of an example method according to the present invention.

FIG. 7 is a schematic illustration of an example method according to the present invention.

FIG. 8 is a schematic illustration of an example method according to the present invention.

FIG. 9 is a schematic illustration of an example apparatus according to the present invention.

FIG. 10 is a schematic illustration of an example apparatus according to the present invention.

FIG. 11 is a schematic illustration of an example apparatus according to the present invention.

FIG. 12 is a schematic illustration of an example apparatus according to the present invention.

FIG. 13 is a schematic illustration of results obtained using an example method such as that in FIG. 4.

FIG. 14 is a schematic illustration of an example embodiment of the present invention.

FIG. 15 is a schematic illustration of an example method according to the present invention.

FIG. 16 is a schematic illustration of results obtained using an example method such as that in FIG. 15.

### DESCRIPTION OF THE INVENTION

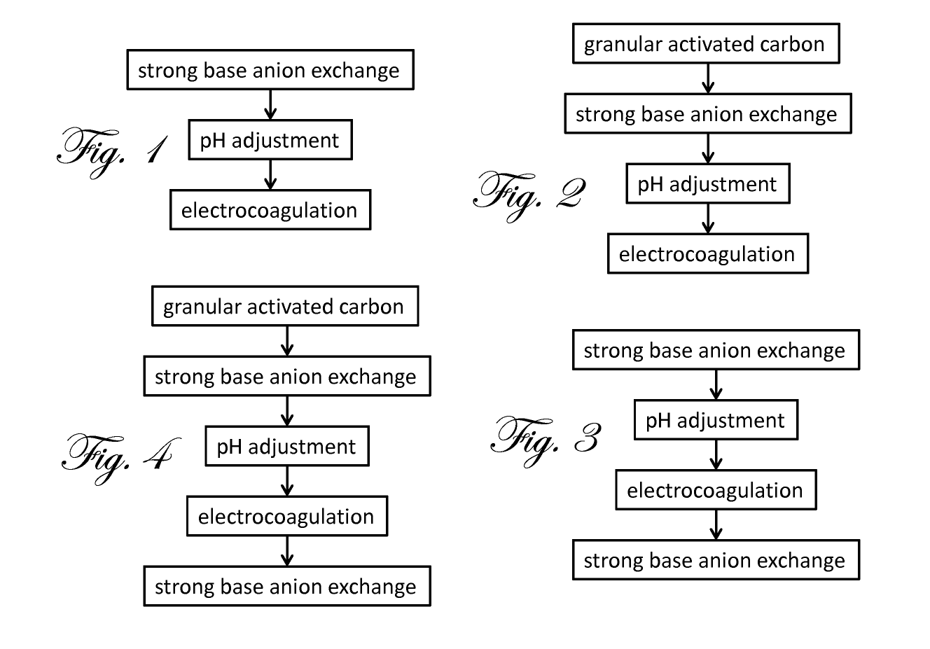

FIG. 1 is a schematic illustration of an example method according to the present invention. Water containing selenium is subjected to a strong base anion exchange process including pH adjustment. The ion exchange process removes sulfate that is often present in the same water as selenium. In order to reduce the retention of selenium in the ion exchange media and maximize the separation between selenium and sulfate when eluting from the ion exchange process, pH adjustment to between 5 and 6.5 for the influent of the ion exchange treatment can be beneficial. The pH of water after such anion exchange process is then adjusted to between 5 and 6.5, for example by introduction of appropriate amounts of hydrochloric acid (HCl) or carbon dioxide gas (CO₂). The pH-adjusted water is then subjected to an electrocoagulation process, including electrocoagulation, flocculation, and settling or filtering or both. Examples of suitable electrocoagulation methods and apparatuses can be adapted from those described in U.S. provisional 60/368,026 filed Mar. 27, 2002; U.S. Pat. No. 6,911,128 filed Sep. 12, 2002; U.S. Pat. No. 7,691,253 filed Apr. 6, 2005; U.S. Pat. No. 7,695,607 filed Apr. 5, 2006; U.S. provisional 60/867,584 filed Nov. 28, 2006; U.S. application Ser. No. 11/946,609 filed Nov. 28, 2007; U.S. application Ser. No. 12/234,658 filed Aug. 21, 2008; U.S. application Ser. No. 12/752,063 filed Mar. 31, 2010; each of which is incorporated herein by reference. Unless the sulfate is first removed in the anion exchange process, the sulfate can overwhelm the electrocoagulation process and prevent that process from removing sufficient selenium.

FIG. 2 is a schematic illustration of an example method according to the present invention. Water containing selenium is subjected to treatment by granular activated carbon (GAC), which treatment removes organics that can overwhelm a subsequent anion exchange process. Water after the GAC treatment is then subjected to a strong base anion exchange process including pH adjustment. The ion exchange process removes sulfate that is often present in the same water as selenium. In order to reduce the retention of selenium in the ion exchange media and maximize the separation between selenium and sulfate when eluting from the ion exchange process, pH adjustment to between 5 and 6.5 for the influent of the ion exchange treatment can be beneficial. The pH of water after such anion exchange process is then adjusted to between 5 and 6.5, for example by introduction of appropriate amounts of HCl or CO₂. The pH-adjusted water is then subjected to an electrocoagulation process, including electrocoagulation, flocculation, and settling or filtering or both. Examples of suitable electrocoagulation methods and apparatuses can be adapted from those described in U.S. provisional 60/368,026 filed Mar. 27, 2002; U.S. Pat. No. 6,911,128 filed Sep. 12, 2002; U.S. Pat. No. 7,691,253 filed Apr. 6, 2005; U.S. Pat. No. 7,695,607 filed Apr. 5, 2006; U.S. provisional 60/867,584 filed Nov. 28, 2006; U.S. application Ser. No. 11/946,609 filed Nov. 28, 2007; U.S. application Ser. No. 12/234,658 filed Aug. 21, 2008; U.S. application Ser. No. 12/752,063 filed Mar. 31, 2010; each of which is incorporated herein by reference. Unless the sulfate is first removed in the anion exchange process, the sulfate can overwhelm the electrocoagulation process and prevent that process from removing sufficient selenium.

FIG. 3 is a schematic illustration of an example method according to the present invention. Water containing selenium is subjected to a strong base anion exchange process including pH adjustment. The ion exchange process removes sulfate that is often present in the same water as selenium. In order to reduce the retention of selenium in the ion exchange media and maximize the separation between selenium and sulfate when eluting from the ion exchange process, pH adjustment to between 5 and 6.5 for the influent of the ion exchange treatment can be beneficial. The pH of water after such anion exchange process is then adjusted to between 5 and 6.5, for example by introduction of appropriate amounts of HCl or CO₂. The pH-adjusted water is then subjected to an electrocoagulation process, including electrocoagulation, flocculation, and settling or filtering or both. Examples of suitable electrocoagulation methods and apparatuses can be adapted from those described in U.S. provisional 60/368,026 filed Mar. 27, 2002; U.S. Pat. No. 6,911,128 filed Sep. 12, 2002; U.S. Pat. No. 7,691,253 filed Apr. 6, 2005; U.S. Pat. No. 7,695,607 filed Apr. 5, 2006; U.S. provisional 60/867,584 filed Nov. 28, 2006; U.S. application Ser. No. 11/946,609 filed Nov. 28, 2007; U.S. application Ser. No. 12/234,658 filed Aug. 21, 2008; U.S. application Ser. No. 12/752,063 filed Mar. 31, 2010; each of which is incorporated herein by reference. Unless the sulfate is first removed in the anion exchange process, the sulfate can overwhelm the electrocoagulation process and prevent that process from removing sufficient selenium. Water after the electrocoagulation treatment is subjected to a finishing process, such as another strong base anion exchange process or an adsorptive process using a material such as activated alumina, which can remove remaining selenium if the concentration after electrocoagulation treatment is higher than desired.

FIG. 4 is a schematic illustration of an example method according to the present invention. Water containing selenium is subjected to treatment by granular activated carbon (GAC), which treatment removes organics that can overwhelm a subsequent anion exchange process. Water after the GAC treatment is then subjected to a strong base anion exchange process including pH adjustment. The ion exchange process removes sulfate that is often present in the same water as selenium. In order to reduce the retention of selenium in the ion exchange media and maximize the separation between selenium and sulfate when eluting from the ion exchange process, pH adjustment to between 5 and 6.5 for the influent of the ion exchange treatment can be beneficial. The pH of water after such anion exchange process is then adjusted to between 5 and 6.5, for example by introduction of appropriate amounts of HCl or CO₂. The pH-adjusted water is then subjected to an electrocoagulation process, including electrocoagulation, flocculation, and settling or filtering or both. Examples of suitable electrocoagulation methods and apparatuses can be adapted from those described in U.S. provisional 60/368,026 filed Mar. 27, 2002; U.S. Pat. No. 6,911,128 filed Sep. 12, 2002; U.S. Pat. No. 7,691,253 filed Apr. 6, 2005; U.S. Pat. No. 7,695,607 filed Apr. 5, 2006; U.S. provisional 60/867,584 filed Nov. 28, 2006; U.S. application Ser. No. 11/946,609 filed Nov. 28, 2007; U.S. application Ser. No. 12/234,658 filed Aug. 21, 2008; U.S. application Ser. No. 12/752,063 filed Mar. 31, 2010; each of which is incorporated herein by reference. Unless the sulfate is first removed in the anion exchange process, the sulfate can overwhelm the electrocoagulation process and prevent that process from removing sufficient selenium. Water after the electrocoagulation treatment is subjected to a finishing process, such as another strong base anion exchange process or an adsorptive process using a material such as activated alumina, which can remove remaining selenium if the concentration after electrocoagulation treatment is higher than desired.

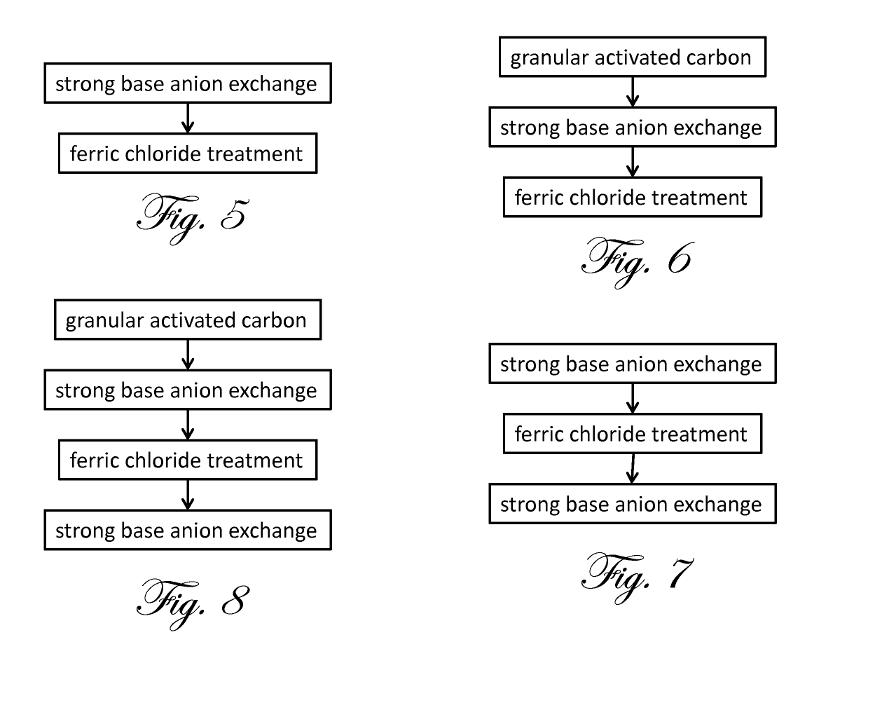

FIG. 5 is a schematic illustration of an example method according to the present invention. Water containing selenium is subjected to a strong base anion exchange process including pH adjustment. The ion exchange process removes sulfate that is often present in the same water as selenium. In order to reduce the retention of selenium in the ion exchange media and maximize the separation between selenium and sulfate when eluting from the ion exchange process, pH adjustment to between 5 and 6.5 for the influent of the ion exchange treatment can be beneficial. The treated water is then subjected to a ferric chloride (FeCl₃) treatment process, including FeCl₃ injection, pH adjustment, flocculation, settling or filtering or both. Ferric chloride is often available in solution with HCl, so an adjustment of pH to between 5 and 6.5 after FeCl₃ injection, for example by addition of NaOH, can be beneficial. Unless the sulfate is first removed in the anion exchange process, the sulfate can overwhelm the action of the ferric chloride and prevent that process from removing sufficient selenium.

FIG. 6 is a schematic illustration of an example method according to the present invention. Water containing selenium is subjected to treatment by granular activated carbon (GAC), which treatment removes organics that can overwhelm a subsequent anion exchange process. Water after the GAC treatment is then subjected to a strong base anion exchange process including pH adjustment. The ion exchange process removes sulfate that is often present in the same water as selenium. In order to reduce the retention of selenium in the ion exchange media and maximize the separation between selenium and sulfate when eluting from the ion exchange process, pH adjustment to between 5 and 6.5 for the influent of the ion exchange treatment can be beneficial. The treated water is then subjected to a ferric chloride treatment process, including FeCl₃ injection, pH adjustment, flocculation, settling or filtering or both. Ferric chloride is often available in solution with HCl, so an adjustment of pH to between 5 and 6.5 after FeCl₃ injection, for example by addition of NaOH, can be beneficial. Unless the sulfate is first removed in the anion exchange process, the sulfate can overwhelm the action of the ferric chloride and prevent that process from removing sufficient selenium.

FIG. 7 is a schematic illustration of an example method according to the present invention. Water containing selenium is subjected to a strong base anion exchange process including pH adjustment. The ion exchange process removes sulfate that is often present in the same water as selenium. In order to reduce the retention of selenium in the ion exchange media and maximize the separation between selenium and sulfate when eluting from the ion exchange process, pH adjustment to between 5 and 6.5 for the influent of the ion exchange treatment can be beneficial. The treated water is then subjected to a ferric chloride treatment process, including FeCl₃ injection, pH adjustment, flocculation, settling or filtering or both. Ferric chloride is often available in solution with HCl, so an adjustment of pH to between 5 and 6.5 after FeCl₃ injection, for example by addition of NaOH, can be beneficial. Unless the sulfate is first removed in the anion exchange process, the sulfate can overwhelm the action of the ferric chloride and prevent that process from removing sufficient selenium. Water after the ferric chloride treatment is subjected to a finishing process, such as another strong base anion exchange process or an adsorptive process using a material such as activated alumina, which can remove remaining selenium if the concentration after the ferric chloride treatment process is higher than desired.

FIG. 8 is a schematic illustration of an example method according to the present invention. Water containing selenium is subjected to treatment by granular activated carbon (GAC), which treatment removes organics that can overwhelm a subsequent anion exchange process. Water after the GAC treatment is then subjected to a strong base anion exchange process including pH adjustment. The ion exchange process removes sulfate that is often present in the same water as selenium. In order to reduce the retention of selenium in the ion exchange media and maximize the separation between selenium and sulfate when eluting from the ion exchange process, pH adjustment to between 5 and 6.5 for the influent of the ion exchange treatment can be beneficial. The treated water is then subjected to a ferric chloride treatment process, including FeCl₃ injection, pH adjustment, flocculation, settling or filtering or both. Ferric chloride is often available in solution with HCl, so an adjustment of pH to between 5 and 6.5 after FeCl₃ injection, for example by addition of NaOH, can be beneficial. Unless the sulfate is first removed in the anion exchange process, the sulfate can overwhelm the action of the ferric chloride and prevent that process from removing sufficient selenium. Water after the ferric chloride treatment is subjected to a finishing process, such as another strong base anion exchange process or an adsorptive process using a material such as activated alumina, which can remove remaining selenium if the concentration after the ferric chloride treatment process is higher than desired.

Granular Activated Carbon. Suitable material is generally available from commercial sources, and can be placed in a reactor vessel such as a pressurized tank suitable for containing the material. A flow rate of about 5 gpm (gallons per minute) per square foot of bed area can be suitable with a 12-40 mesh bed of granular activated carbon, with a contact time of about 2 minutes.

Strong Base Anion Exchange Treatment. A strong base anion exchange resin can be added to a reactor vessel such as a pressurized tank suitable for containing the medium. Suitable resins are available from commercial sources, e.g., http://www.dow.com/liquidseps/prod/sbati.htm, visited May 21, 2010, and incorporated herein by reference, has a list of such resins. As examples, Dowex Marathon 11, Dowex MSA, and Amberjet 4200 can be suitable for sulfate removal. The reactor vessel, resin configuration, and flow rate can be balanced to provide about 1.6 minutes contact of the water with the resin, and about 5 gpm water flow per square foot of bed area.

pH Adjustment. An acid such as 38% Hydrochloric (HCl) or carbon dioxide gas (CO₂), or a base such as 50% NaOH, available from commercial sources, can be added to the water by injection with a chemical metering pump. The pH can be sensed before injection and the injection rate determined therefrom. Or the pH can be sensed after injection and the injection controlled to provide the desired result, or a combination thereof. Other approaches and materials to adjust pH are known and can be suitable, but the pH adjustment step should be performed in a manner that does not interfere with other steps in the process. After injection of HCl or NaOH, a rapid mixer or static mixer can be used to facilitate thorough mixing of HCl or NaOH with the water.

Electrocoagulation. Electrocoagulation can be done as described above. High grade iron plates can be used. Other metals, such as aluminum and titanium, can also be suitable in some applications of the present invention. Plate current can be selected to match the operating conditions (e.g., level of incoming selenium, flow rate) and performance desired (e.g., desired selenium removal rate).

Ferric Chloride Treatment. Ferric chloride, e.g., 38% ferric chloride, is widely available from commercial sources, and can be injected with a chemical metering pump. Injection can be done at rates to match input contamination and flow rates of rest of system. A rapid mixer or static mixer can be used in connection with the injection to facilitate rapid distribution of the ferric chloride throughout the water being treated.

FIG. 13 is a schematic illustration of results obtained using an example method such as that in FIG. 3. The method of FIG. 3 was operated to reduce the concentration of selenium in refinery wastewater to less than 5 ppb. Results of operation with input wastewater having 86 ppb selenium are shown in FIG. 13. In the figure, “Influent” refers to the refinery effluent wastewater input to the system; “Post-IX” refers to water after an anion exchange process for SO₄²⁻ removal; “Post-EC” refers to water after electrocoagulation treatment; “Post-AA” refers to water after treating with activated alumina. Similar trends in reduction of selenium concentration were observed for input selenium concentration of about 200 ppb. Similar performance was obtained practicing other example methods described herein.

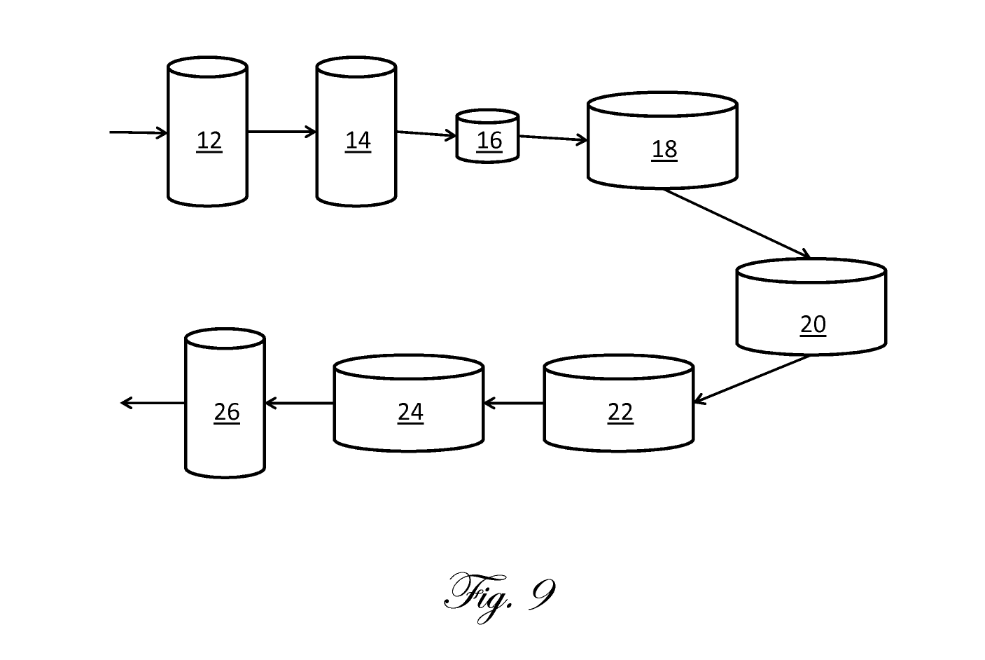

FIG. 9 is a schematic illustration of an example apparatus according to the present invention. Incoming water is routed, for example by conventional plumbing, to a granular activated carbon treatment subsystem 12. The granular activated carbon treatment subsystem is in fluid communication with a first strong base anion exchange subsystem 14, such that output water from the granular activated carbon treatment subsystem 12 can be input to the first strong base anion exchange subsystem 14. The strong base anion exchange subsystem 14 is in fluid communication with a pH control subsystem 16, such that water output from the strong base anion exchange subsystem 14 can be input to the pH control subsystem 16. The pH control subsystem 16 is in fluid communication with an electrocoagulation subsystem 18, such that water output from the pH control subsystem 16 can be input to the electrocoagulation subsystem 18. The electrocoagulation subsystem 18 is in fluid communication with a flocculation subsystem 20, such that water output from the electrocoagulation subsystem 18 can be input to the flocculation subsystem 20. A clarification subsystem 22 is in fluid communication with the flocculation subsystem 20, such that water output from the flocculation subsystem 20 can be input to the clarification subsystem 22. A filtration subsystem 24 is in fluid communication with the clarification subsystem 22, such that water output from the clarification subsystem can be input to the filtration subsystem 24. A second strong base anion exchange subsystem 26 is in fluid communication with the filtration subsystem 24, such that water output from the filtration subsystem 24 can be input to the second strong base anion exchange subsystem 26. Water output from the second strong base anion exchange subsystem 26 is output from the apparatus as water with selenium concentration reduced to a desired level.

Flocculation subsystem. The system is operable without the flocculation subsystem in some applications, and the flocculation subsystem can be omitted. If present, it can encourage floc aggregation. The flocculation subsystem can be implemented as a slow mixing of the water, allowing floc to collide, and aggregate.

Clarification subsystem. The system is operable without the clarification subsystem in some applications, and the clarification subsystem can be omitted. If present, it can remove some of the floc. The clarification subsystem can be implemented as a slow flow region, allowing flocs to settle out of the water. A clarification subsystem can also comprise a parallel plate high rate clarifier, with upwards water flow there through.

Filtration subsystem. The filtration subsystem can remove floc left after electrocoagulation or ferric chloride treatment, and after the flocculation subsystem and clarification subsystem, if present. It can be implemented with standard filter design and operation techniques. For example, 0.5-mm nominal diameter silica sand can provide suitable filtration. Hydraulic loading rate of 5 gpm per square foot of filter surface area can be suitable.

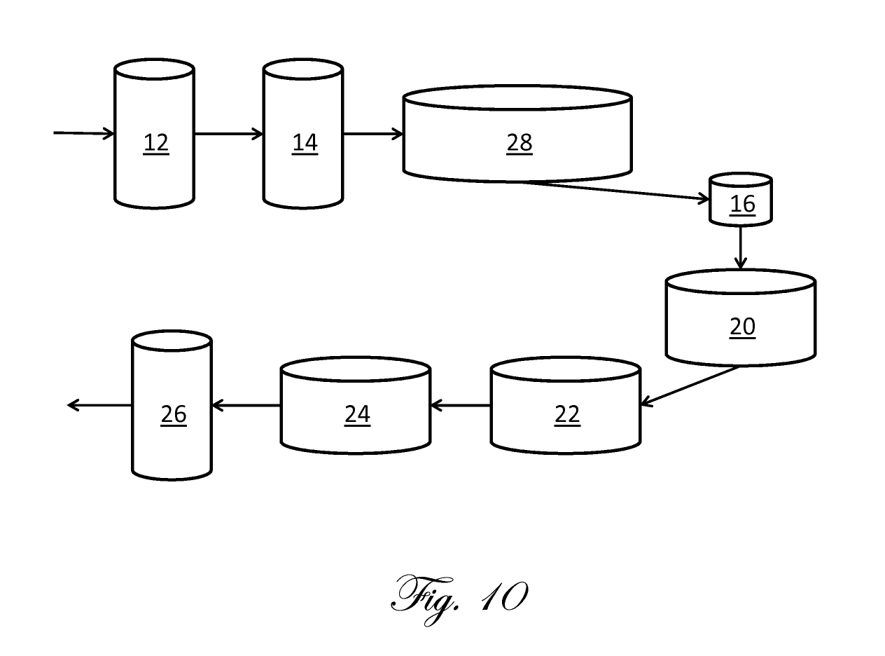

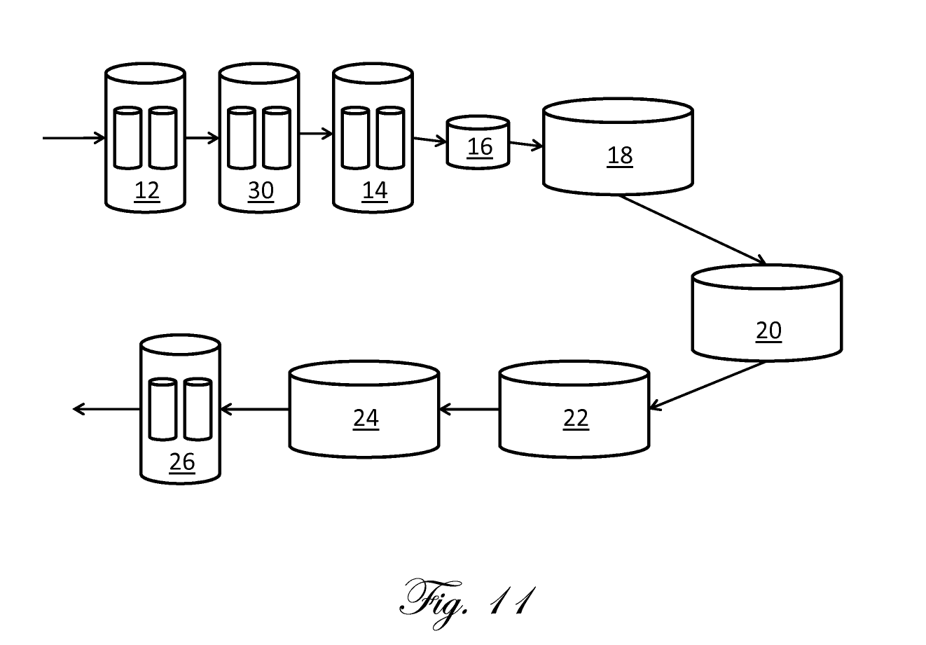

FIG. 10 is a schematic illustration of an example apparatus according to the present invention. Incoming water is routed, for example by conventional plumbing, to a granular activated carbon treatment subsystem 12. The granular activated carbon treatment subsystem is in fluid communication with a first strong base anion exchange subsystem 14, such that output water from the granular activated carbon treatment subsystem 12 can be input to the first strong base anion exchange subsystem 14. The strong base anion exchange subsystem 14 is in fluid communication with a ferric chloride treatment subsystem 28, such that water output from the strong base anion exchange subsystem 14 can be input to the ferric chloride treatment subsystem 28. The ferric chloride treatment subsystem 28 is in fluid communication with a pH control subsystem 16, such that water output from the ferric chloride subsystem 28 can be input to the pH control subsystem 16. The pH control subsystem 16 is in fluid communication with a flocculation subsystem 20, such that water output from the pH control subsystem 16 can be input to the flocculation subsystem 20. A clarification subsystem 22 is in fluid communication with the flocculation subsystem 20, such that water output from the flocculation subsystem 20 can be input to the clarification subsystem 22. A filtration subsystem 24 is in fluid communication with the clarification subsystem 22, such that water output from the clarification subsystem can be input to the filtration subsystem 24. A second strong base anion exchange subsystem 26 is in fluid communication with the filtration subsystem 24, such that water output from the filtration subsystem 24 can be input to the second strong base anion exchange subsystem 26. Water output from the second strong base anion exchange subsystem 26 is output from the apparatus as water with selenium concentration reduced to a desired level.

FIG. 11 is a schematic illustration of an example apparatus according to the present invention. Subsystems in FIG. 11 with similar numbers are similar to the subsystems described in connection with FIG. 9. A third strong base anion exchange subsystem 30 is in fluid communication with the granular activated carbon treatment subsystem 12 and the first strong base anion exchange subsystem 14, such that water output from the granular activated carbon treatment subsystem can be input to the third strong base anion exchange subsystem 30, and water output from the third strong base anion exchange subsystem 30 can be input to the first strong base anion exchange subsystem 14. The third strong base anion exchange subsystem 30 can further scavenge organics from the water, if the condition of the input water makes such further scavenging desirable. The granular activated carbon treatment subsystem 12 comprises two or more separately serviceable granular activated carbon units, which can allow replacement, service, or regeneration of one unit while the overall system remains in substantially continuous operation. Each of the strong base anion exchange subsystems 14, 26, 30 comprises two or more separately serviceable strong base anion exchange units, which can allow replacement, service, or regeneration of one unit while the overall system remains in substantially continuous operation. While the figure shows two units in each of the aforementioned subsystems, those skilled in the art will appreciate that some of the subsystems can have a single unit, or can have more than two units.

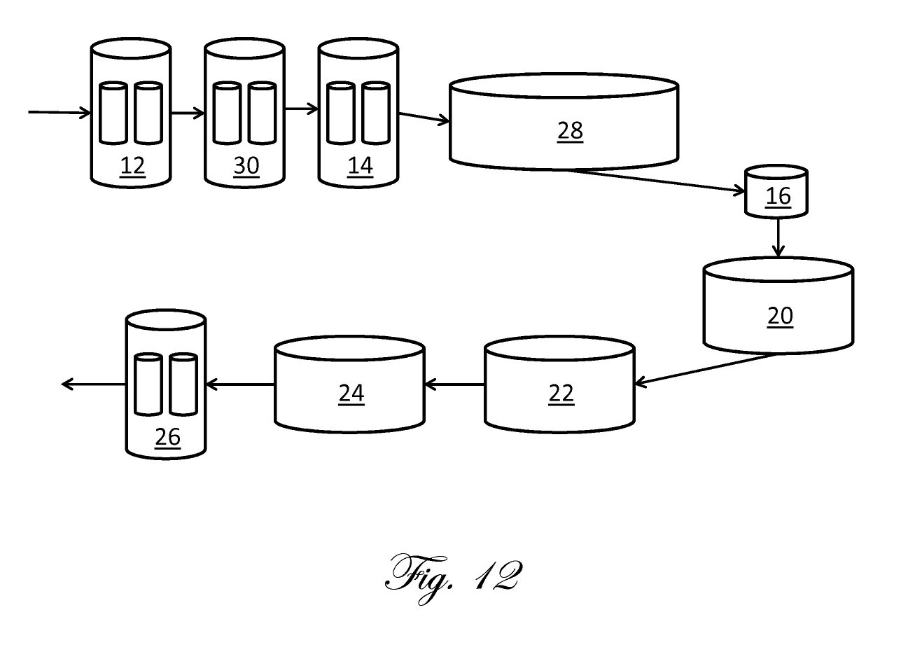

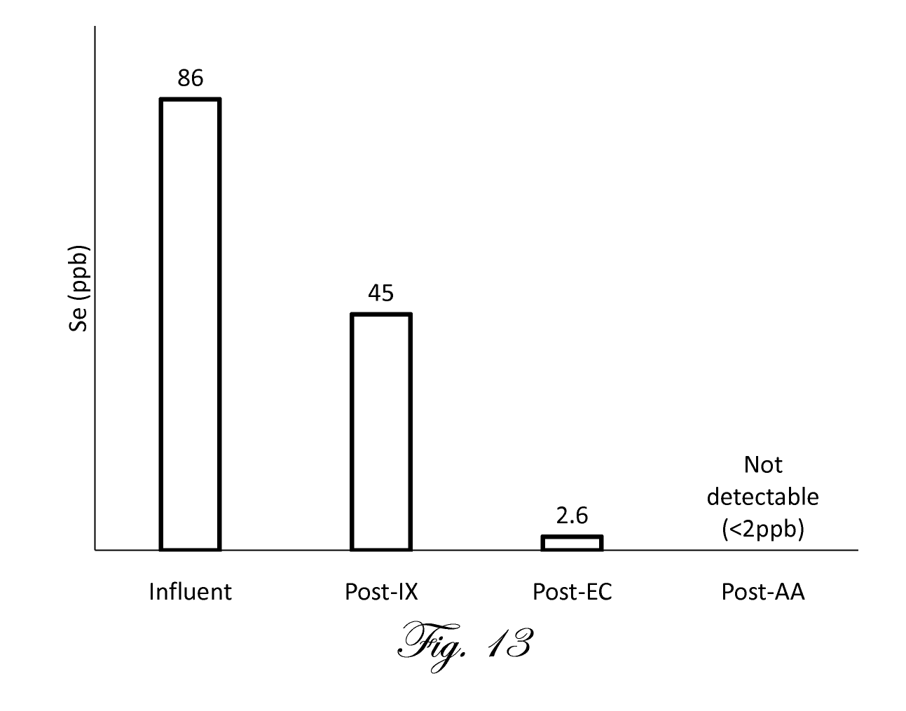

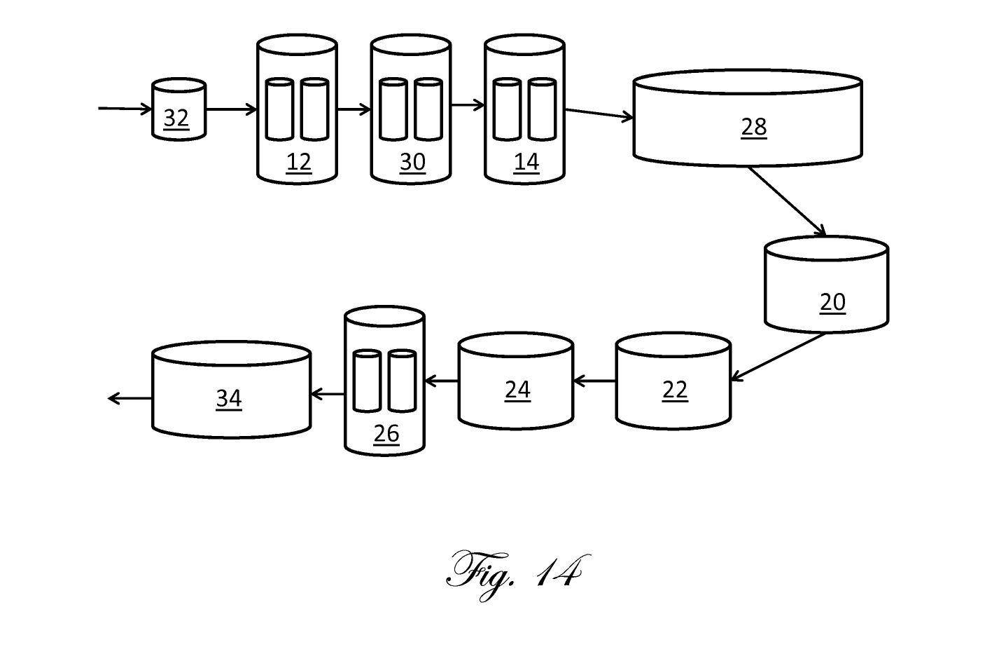

FIG. 12 is a schematic illustration of an example apparatus according to the present invention. Subsystems in FIG. 12 with similar numbers are similar to the subsystems described in connection with FIG. 10. A third strong base anion exchange subsystem 30 is in fluid communication with the granular activated carbon treatment subsystem 12 and the first strong base anion exchange subsystem 14, such that water output from the granular activated carbon treatment subsystem can be input to the third strong base anion exchange subsystem 30, and water output from the third strong base anion exchange subsystem 30 can be input to the first strong base anion exchange subsystem 14. The third strong base anion exchange subsystem 30 can further scavenge organics from the water, if the condition of the input water makes such further scavenging desirable. The granular activated carbon treatment subsystem 12 comprises two or more separately serviceable granular activated carbon units, which can allow replacement, service, or regeneration of one unit while the overall system remains in substantially continuous operation. Each of the strong base anion exchange subsystems 14, 26, 30 is comprises two or more separately serviceable strong base anion exchange units, which can allow replacement, service, or regeneration of one unit while the overall system remains in substantially continuous operation. While the figure shows two units in each of the aforementioned subsystems, those skilled in the art will appreciate that some of the subsystems can have a single unit, or can have more than two units.

FIG. 14 is a schematic illustration of an example embodiment of the present invention. Incoming water first encounters a filter 32, such as a 5-μm cartridge filter, which can be used to remove suspended solids from the water. Water from the filter 32 is then treated by a granular activated carbon subsystem 12, such as a two column system that allows regeneration or maintenance of one column without requiring significant downtime for the overall system. Treatment by the granular activated carbon subsystem can reduce the level of dissolved organic compounds that could potentially foul the downstream processes. Water from the granular activated carbon subsystem is then treated by a third ion exchange subsystem 30, such as a dual column subsystem that allows regeneration or maintenance of one column without requiring significant downtime for the overall system. This treatment can provide organic scavenging to further reduce the level of dissolved organic compounds. Water from the third ion exchange subsystem 30 is then treated by a first ion exchange subsystem 14, such as a dual column subsystem that allows regeneration or maintenance of one column without requiring significant downtime for the overall system. This treatment can provide the removal of sulfate that can interfere with selenium removal processes of subsequent subsystems. Water from the first ion exchange subsystem 14 is then treated by a selenium removal subsystem 28, which can comprise an electrocoagulation subsystem with iron plates or straight ferric chloride injection to remove the majority of the selenium via Fe(OH)₃ adsorption. Selenium-laden flocs from such treatment are then removed by any combination of flocculation 20, high-rate clarification 22 (e.g., a tube settler), and granular-media filtration 24. After floc removal, water is subjected to a second ion exchange subsystem 26, such as a dual column subsystem that allows regeneration or maintenance of one column without requiring significant downtime for the overall system. This treatment can reduce the residual selenium concentration further, for example to below 5 ppb in some applications. Water from the second ion exchange subsystem 26 can be sent to a finished water reservoir 34 before discharge. Water from the finished water reservoir 34 can be used for backwashing and regeneration purposes.

Not shown in detail in the various schematic illustrations are fluid transport and control systems common in the art. Those skilled in the art will appreciate various pump, pipe, and valve arrangements to accommodate the fluid flow described in relation to the example embodiments.

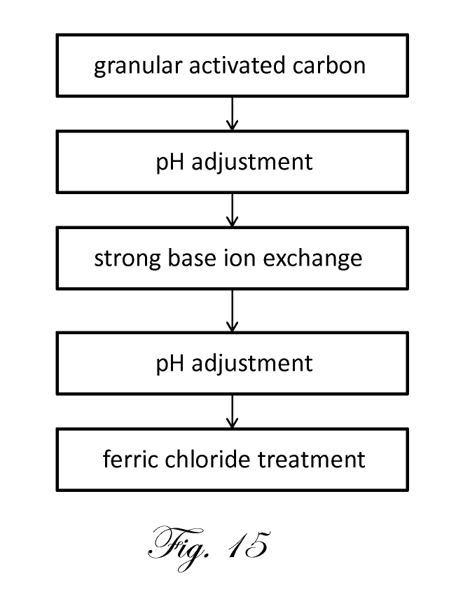

An example embodiment such as that in FIG. 13 can be constructed and housed in a 16-foot trailer, and can accommodate a flow rate of about 0.25 gallons per minute. Larger systems with higher flow rates can also be employed. Examples of specific implementations of the various subsystems described in relation to FIG. 15 include the following.

Granular Activated Carbon.
Configuration: duel-column
   5.5 ft (H)×3 in (D)
Media: Calgon Filtrasorb 400
Size: 12×40 mesh
Bed depth: 2.6 ft
Bed volume: 0.13 ft³
Hydraulic loading rate (HLR): 5 gpm/ft²
Contact time: 2 minutes

Ion Exchange for Organic Scavenging.
Configuration: duel-column
   5.5 ft (H)×3 in (D)
Media: Dowex Marathon 11
Ion exchange capacity 1.3 meq/ml of wetted volume
Size: 550±50 μm
Bed depth: 2.6 ft
Bed volume: 0.13 ft³
Hydraulic loading rate (HLR): 5 gpm/ft²
Contact time: 1.6 minutes

Ion Exchange for Sulfate Removal.
Configuration: duel-column
   5.5 ft (H)×3 in (D)
Media: Dowex MSA
Ion exchange capacity 1.1 meq/ml of wetted volume
Size: 640±50 μm
Bed depth: 2.6 ft
Bed volume: 0.13 ft³
Hydraulic loading rate (HLR): 5 gpm/ft²
Contact time: 1.6 minutes

Electrocoagulation or Addition of Ferric Chloride.
Iron (III) dose: <219 ppm of F³⁺
Reaction time: 10 minutes for EC
   30 seconds for FeCl₃ addition
pH adjustment: with HCl to 6.5 before EC treatment
   with NaOH to 6.5 immediately after FeCl₃ addition

Ion Exchange for Final Polishing.
Configuration: dual-column
   5.5 ft (H)×3 in (D)
Media: Dowex MSA
Ion exchange capacity 1.1 meq/ml of wetted volume
Size: 640±50 μm
Bed depth: 2.6 ft
Bed volume: 0.13 ft³
Hydraulic loading rate (HLR): 2.5 gpm/ft²
Contact time: 3.2 minutes

FIG. 15 is a schematic illustration of an example method according to the present invention. Walk through.

FIG. 15 is a schematic illustration of an example method according to the present invention. Water containing selenium is subjected to treatment by granular activated carbon (GAC), which treatment removes organics that can overwhelm a subsequent anion exchange process. The pH of the water after treatment by granular activated carbon is then adjusted, for example to between about 5 and about 6.5. Water after the pH adjustment is then subjected to a strong base anion exchange process. The ion exchange process removes sulfate that is often present in the same water as selenium. In order to reduce the retention of selenium in the ion exchange media and maximize the separation between selenium and sulfate when eluting from the ion exchange process, pH adjustment to between about 5 and about 6.5 for the influent of the ion exchange treatment can be beneficial. The pH of water after such anion exchange process can be adjusted to between 5 and 6.5, for example by introduction of appropriate amounts of HCl or CO₂. The pH-adjusted water is then subjected to an electrocoagulation process, including electrocoagulation, flocculation, and settling or filtering or both. Examples of suitable electrocoagulation methods and apparatuses can be adapted from those described in U.S. provisional 60/368,026 filed Mar. 27, 2002; U.S. Pat. No. 6,911,128 filed Sep. 12, 2002; U.S. Pat. No. 7,691,253 filed Apr. 6, 2005; U.S. Pat. No. 7,695,607 filed Apr. 5, 2006; U.S. provisional 60/867,584 filed Nov. 28, 2006; U.S. application Ser. No. 11/946,609 filed Nov. 28, 2007; U.S. application Ser. No. 12/234,658 filed Aug. 21, 2008; U.S. application Ser. No. 12/752,063 filed Mar. 31, 2010; each of which is incorporated herein by reference. Unless the sulfate is first removed in the anion exchange process, the sulfate can overwhelm the electrocoagulation process and prevent that process from removing sufficient selenium.

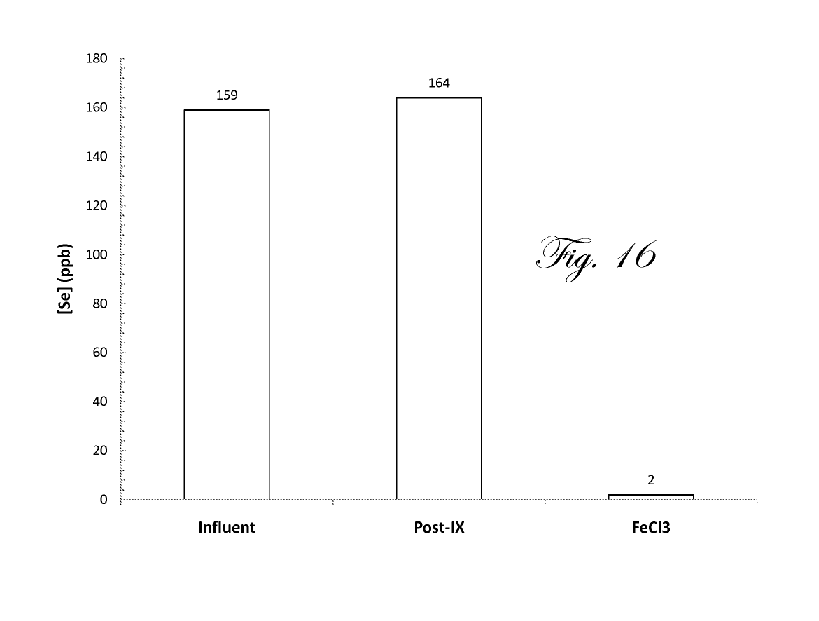

FIG. 16 is an illustration of results obtained by practice of the method illustrated in FIG. 15. FIG. 16 depicts the selenium concentrations through treatment process using GAC, pH adjustment, strong base anion exchange, pH adjustment, and FeCl3 addition. The influent concentration is after the GAC treatment step and total iron concentration from FeCl3 addition is 114 ppm.

The particular sizes and equipment discussed above are cited merely to illustrate particular embodiments of the invention. It is contemplated that the use of the invention can involve components having different sizes and characteristics. It is intended that the scope of the invention be defined by the claims appended hereto.

We claim:

1. A method of reducing selenium concentration in water, comprising:
a. Subjecting input water to a sulfate removal process; and then
b. Subjecting the sulfate-depleted water to a selenium removal process.

2. A method as in claim 1, wherein the sulfate is removed by at least one of: a strong base anion exchange, or barium sulfate precipitation.

3. A method as in claims 1 and 2, wherein sulfate is removed by a strong base anion exchange process with either hydroxyl or chloride based anion exchange media.

4. A method as in claim 3, further comprising adjusting the pH of the water to between 5 to 6.5 before the strong anion exchange sulfate removal process.

5. A method as in claim 1, wherein the selenium removal process comprises mixing of the sulfate-depleted water with ferric chloride.

6. A method as in claim 1, wherein the selenium removal process comprises an electrocoagulation process.

7. A method as in claim 5, further comprising adjusting the pH of the sulfate-depleted water to between 5 and 6.5 before the addition of ferric chloride.

8. A method as in claim 6, further comprising adjusting the pH of the sulfate-depleted water to about 6.5 before the electrocoagulation process.

9. A method as in claim 1, further comprising treating the input water with granular activated carbon before the strong base anion exchange process.

10. An apparatus for the removal of selenium from water, comprising:
a. A granular activated carbon treatment subsystem, configured to accept input water and to remove organics from water;
b. A first strong base anion exchange subsystem, in fluid communication with the granular activated carbon treatment subsystem, wherein the strong base anion exchange subsystem is configured to remove sulfate from water;
c. A selenium removal subsystem, in fluid communication with the first strong base anion exchange subsystem, and comprising a pH control system;
d. A filtration subsystem, in fluid communication with the selenium removal subsystem, configured to remove selenium-containing floc from water, and to output water.

11. An apparatus as in claim 10, wherein the selenium removal subsystem comprises an electrocoagulation subsystem.

12. An apparatus as in claim 11, wherein the electrocoagulation subsystem comprises a pH control subsystem.

13. An apparatus as in claim 10, wherein the selenium removal subsystem comprises a system for mixing ferric chloride with water.

14. An apparatus as in claim 10, further comprising a flocculation subsystem mounted between and in fluid communication with the selenium removal subsystem and the filtration subsystem.

15. An apparatus as in claim 10, further comprising a clarification subsystem mounted between and in fluid communication with the selenium removal subsystem and the filtration subsystem.

16. An apparatus as in claim 10, wherein the strong base anion exchange subsystem comprises a dual column system.
